(19) United States
(12) Patent Application Publication
(10) Pub. No.: US 2010/0070688 A1
(43) Pub. Date: Mar. 18, 2010

(54) FLASH MEMORY DEVICE AND METHOD FOR WRITING DATA THERETO

(75) Inventor: Tsai-Cheng Lin, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: SILICON MOTION, INC., Hsinchu County (TW)

(21) Appl. No.: 12/548,727

(22) Filed: Aug. 27, 2009

Related U.S. Application Data
(60) Provisional application No. 61/097,627, filed on Sep. 17, 2008.
(60) Provisional application No. 61/180,168, filed on May 21, 2009.

(51) Int. Cl. G06F 12/00; G06F 12/02

(52) U.S. Cl. 711/103; 711/E12.001; 711/E12.008

(57) ABSTRACT

The invention provides a flash memory device. In one embodiment, the flash memory device is coupled to a host, and comprises a multiple-level-cell (MLC) flash memory and a controller. The MLC flash memory comprises a turbo area and a normal area, wherein the turbo area comprises a plurality of first blocks, the normal area comprises a plurality of second blocks, and each of the first blocks and the second blocks comprises a plurality of pages, wherein the pages of the first blocks and the second blocks are divided into strong pages with high data endurance and weak pages with low data endurance. The controller receives data to be written to the MLC flash memory from the host, determines whether the data is important data, and writes the data to the strong pages of the first blocks of the turbo area when the data is important data.

### CROSS REFERENCE TO RELATED APPLICATIONS

This application claims the benefit of U.S. Provisional Application No. 61/097,627, filed on Sep. 17, 2008, and U.S. Provisional Application No. 61/180,168, filed on May 21, 2009, the entirety of which are incorporated by reference herein.

### BACKGROUND OF THE INVENTION

1. Field of the Invention

The invention relates to flash memory devices, and more particularly to multiple-level-cell (MCL) flash memory devices.

2. Description of the Related Art

NAND flash memories are classified into single-level-cell (SLC) flash memories and multiple-level-cell (MLC) flash memories. A memory cell of a SLC flash memory can only store a single data bit. A memory cell of an MLC flash memory, however, can store a plurality of data bits. When an MLC flash memory has the same number of memory cells as that of an SLC flash memory, the MLC flash memory has greater data storage capacity than that of the SLC flash memory. The MLC flash memory therefore has lower manufacturing cost than the SLC flash memory.

An MLC flash memory comprises a plurality of blocks, and each of the blocks comprises a plurality of pages for storing data. The pages of the MLC flash memory are divided into weak pages and strong pages. An MLC flash memory has the same number of strong pages and weak pages. Weak pages have lower data endurance, lower data retention, and a slower data access speed than those of strong pages. In general, pages of an SLC flash memory have higher data endurance, higher data retention, and a faster data access speed than those of an MLC flash memory.

Data used by a host can be roughly divided into system data and user data. System data has higher importance and requires storage in a storage area with higher data endurance, higher data retention, and a faster data access speed. User data requires storage in a storage area with greater storage capacity. To meet requirements of system data and user data, a conventional flash memory device needs to be equipped with two kinds of flash memories respectively corresponding to system data and user data. Referring to FIG. 1, a block diagram of a conventional flash memory device 100 is shown. The flash memory device 100 comprises a controller 112 and two flash memories 114 and 116. The flash memory 114 is a NOR flash memory or an SLC flash memory with higher data endurance, higher data retention, and a faster data access speed. The flash memory 116 is an MLC flash memory with large data capacity.

Because the conventional flash memory device 104 comprises two kinds of flash memories 114 and 116, the conventional flash memory device 104 has high circuit design complexity. For example, the flash memories 114 and 116 may require different data buses and chip enable circuits. A circuit design with higher complexity increases manufacturing costs of the conventional flash memory device 100. A flash memory device comprising a single flash memory which has two data storage areas with different properties respectively suiting system data and user data is therefore required.

### BRIEF SUMMARY OF THE INVENTION

The invention provides a flash memory device. In one embodiment, the flash memory device is coupled to a host, and comprises a multiple-level-cell (MLC) flash memory and a controller. The MLC flash memory comprises a turbo area and a normal area, wherein the turbo area comprises a plurality of first blocks, the normal area comprises a plurality of second blocks, and each of the first blocks and the second blocks comprises a plurality of pages, wherein the pages of the first blocks and the second blocks are divided into strong pages with high data endurance and weak pages with low data endurance. The controller receives data to be written to the MLC flash memory from the host, determines whether the data is important data, writes the data to the strong pages of the first blocks of the turbo area when the data is important data, and writes the data to the pages of the second blocks of the normal area when the data is not important data.

The invention also provides a method for writing data to a flash memory device. In one embodiment, the flash memory device is coupled to a host. First, a plurality of blocks of a multiple-level-cell (MLC) flash memory is divided into a plurality of first blocks of a turbo area and a plurality of second blocks of a normal area, wherein each of the first blocks and the second blocks comprises a plurality of pages, and the pages of the first blocks and the second blocks are classified into strong pages with high data endurance and weak pages with low data endurance. Data to be written to the MLC flash memory is then received from the host. Whether the data is important data is then determined. When the data is important data, the data is then written to the strong pages of the first blocks of the turbo area. When the data is not important data, the data is then written to the pages of the second blocks of the normal area.

The invention also provides a flash memory device. In one embodiment, the flash memory device is coupled to a host, and comprises a plurality of multiple-level-cell (MLC) flash memory and a controller. Each of the MLC flash memories comprises a turbo area and a normal area, wherein the turbo area and the normal area comprises a plurality of blocks, each of the blocks comprises a plurality of pages, and the pages are divided into strong pages with high data endurance and weak pages with low data endurance. The controller receives data to be written to the flash memory device from the host, determines whether the data is important data, writes the data to the strong pages of a plurality of first blocks of the turbo areas of the MLC flash memories when the data is important data, and writes the data to the pages of a plurality of second blocks of the normal areas of the MLC flash memories when the data is not important data, wherein the first blocks have the same indexes in the MLC flash memories, and the second blocks have the same indexes in the MLC flash memories.

The invention also provides a flash memory device. In one embodiment, the flash memory device is coupled to a host, and comprises a turbo multiple-level-cell (MLC) flash memory and a controller. The turbo MLC flash memory comprises a plurality of first blocks, wherein each of the first blocks comprises a plurality of pages, and the pages of the first blocks are divided into strong pages with high data endurance and weak pages with low data endurance. The MLC flash memory comprises a plurality of second blocks, wherein each of the second blocks comprises a plurality of pages. The controller receives data to be stored into the flash memory device from the host, determines whether the data is important data, writes the data to the strong pages of the first blocks of the turbo MLC flash memory when the data is important data, and writes the data to the pages of the second blocks of the MLC flash memory when the data is not important data.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of a conventional flash memory device;

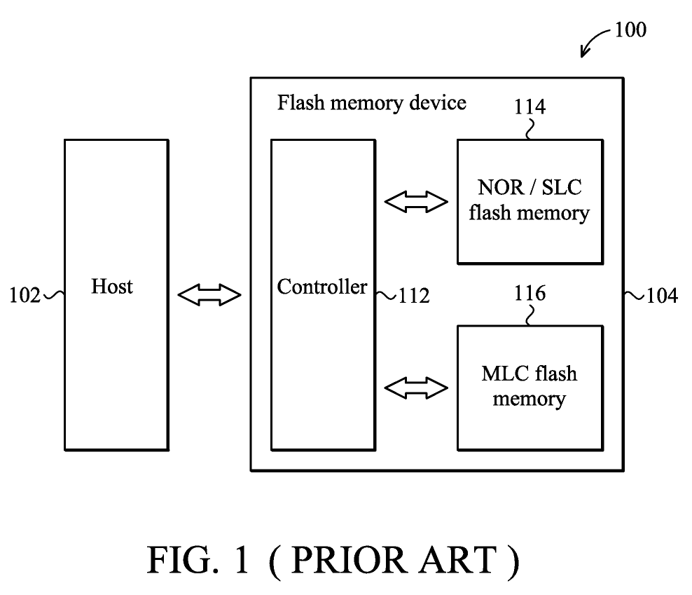

FIG. 2 is a block diagram of a flash memory device according to the invention;

FIG. 3 is a schematic diagram of strong pages and weak pages comprised by a block according to the invention;

FIG. 4 is a flowchart of a method for writing data to an MLC flash memory shown in FIG. 2 according to the invention;

FIG. 5 is a block diagram of an interleaving flash memory device according to the invention;

FIG. 6 is a block diagram of a multi-channel flash memory device according to the invention;

FIG. 7 is a block diagram of a multi-channel interleaving flash memory device according to the invention; and

FIG. 8 is a block diagram of a flash memory device according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

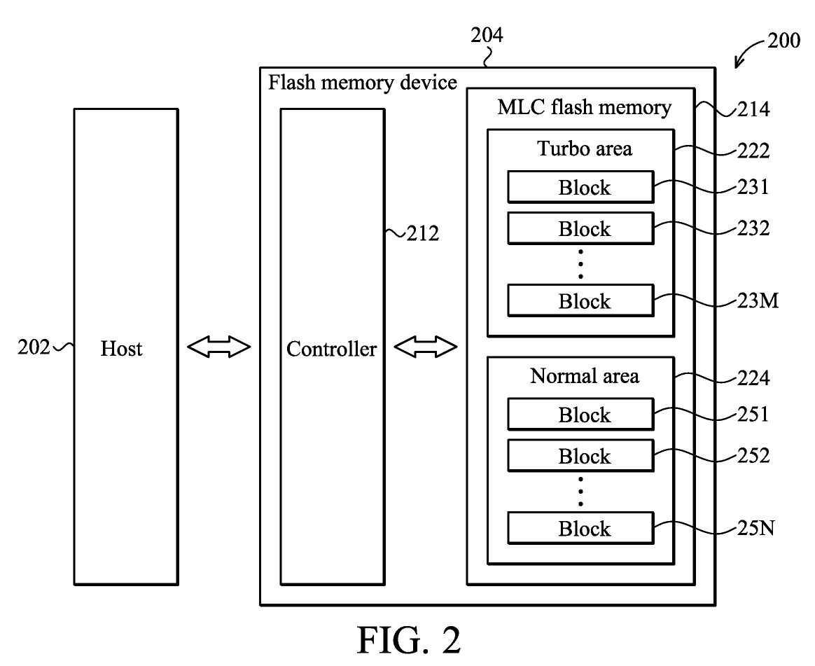

Referring to FIG. 2, a block diagram of a flash memory device 204 according to the invention is shown. The flash memory device 204 is coupled to a host 202, and stores data for the host 202. In one embodiment, the flash storage device 204 comprises a controller 212 and a multiple-level-cell (MLC) flash memory 214. The MLC flash memory 214 comprises a plurality of blocks. The blocks of the MLC flash memory 214 are divided into two groups. Blocks 231˜23M are in a turbo area 222 of the MLC flash memory 214, and blocks 251˜25N are in a normal area 224 of the MLC flash memory 214. Each of the blocks 231˜23M and 251˜25N comprises a plurality of pages for data storage.

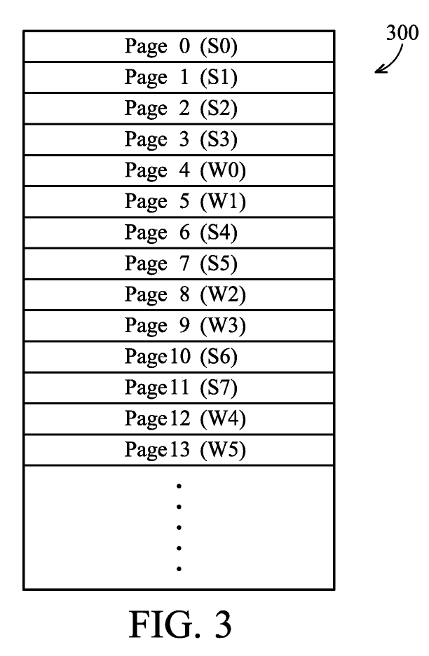

The pages of the blocks 231˜23M and 251˜25N are divided into strong pages and weak pages. Referring to FIG. 3, a schematic diagram of strong pages and weak pages comprised by a block 300 according to the invention is shown. The block 300 comprises a plurality of pages, half of the pages are strong pages, and half of the pages are weak pages. In one embodiment, pages 0, 1, 2, 3, 6, 7, 10, and 11 are strong pages and are respectively marked as pages S0, S1, S2, S3, S4, S5, S6, and S7. Pages 4, 5, 8, 9, 12, and 13 are weak pages and are respectively marked as pages W0, W1, W2, W3, W4, and W5. Strong pages have higher data endurance, higher data retention, and a faster data access speed, and weak pages have lower data endurance, lower data retention, and a slower data access speed. In one embodiment, the controller 212 determines whether a page of the MLC flash memory 214 is a strong page or a weak page according to a page mapping table.

To increase the data access speed for accessing data stored in the turbo area, and increase data endurance and data retention of blocks 231˜23M of the turbo area 222, the controller 212 only stores data in the strong pages of the blocks 231˜23M of the turbo area 222. Because strong pages have higher data endurance, higher data retention, and a faster data access speed, the performance of the turbo area 222 of the MLC flash memory 214 is maximized. In one embodiment, the data endurance of the turbo area 222 is increased by 5 times than that of the normal area 224, and the data retention of the turbo area 222 is increased by 5˜10 times than that of the normal area 224. Because the controller 212 only uses strong pages of the turbo area 222 for data storage, the data capacity of the turbo area 222 is reduced by half.

When the controller 212 stores data to the blocks 251˜25N of the normal area 224, the controller 212 equally stores data to strong pages and weak pages of the blocks 251˜25N to maximize the data storage capacity of the normal area 224. The MLC flash memory 214 therefore has a turbo area 222 with a higher data access speed and a normal area 224 with greater data storage capacity. In one embodiment, to avoid the blocks 231˜23M of the turbo area 222 from being exchanged with the blocks 251˜25N of the normal area 224, the controller 212 independently performs wear-leveling on the blocks 231˜23M of the turbo area 222, independently performs wear-leveling on the blocks 251˜25N of the normal area 224, and does not perform wear-leveling between the blocks 231˜23M of the turbo area 222 and the blocks 251˜25N of the normal area 224. In addition, the controller 212 maintains an address link table for recording a mapping relationship between the logical addresses and physical addresses of the blocks 231˜23M of the turbo area 222, and maintains an address link table for recording a mapping relationship between the logical addresses and physical addresses of the blocks 251˜25N of the normal area 224.

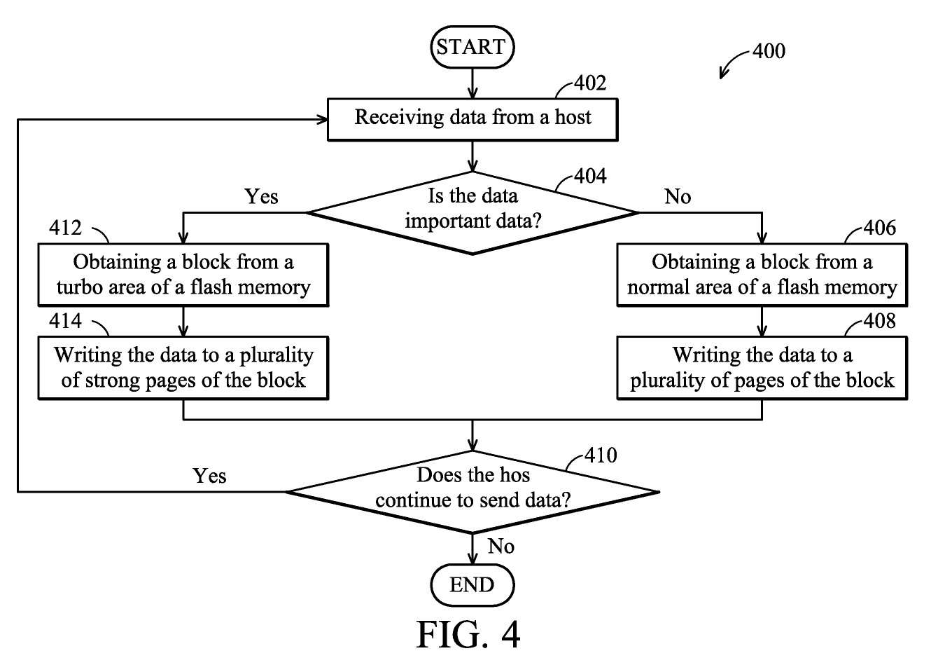

Referring to FIG. 4, a flowchart of a method 400 for writing data to an MLC flash memory 214 shown in FIG. 2 according to the invention is shown. The controller 212 first receives data to be written to the flash memory device 204 from the host 202 (step 402). The controller 212 then determines whether the data is important data (step 404) to determine whether the data is to be written to the blocks 231˜23M of the turbo area 222 or the blocks 251˜25N of the normal area 224. In one embodiment, the controller 212 determines whether the data is system data or user data. When the data is system data, the data is determined to be important data, and when the data is user data, the data is determined to not be important data. In one embodiment, a logical address range used by the host 202 is divided into a first logical address range and a second logical address range according to a boundary value. When the logical address of the data falls in the first logical address range, the controller 212 determines that the data is important data.

Assume that a logical address range used by the host 202 is from 0 to 4095, and the boundary value is set to 1024. The first logical address range is therefore from 0 to 1023, and the second logical address range is from 1024 to 4095. The controller 212 then compares a logical address of the received data with the boundary value to determine whether the received data is important data. In one embodiment, when the logical address of the data is less than the boundary value, the logical address of the data falls in the first logical address range, and the controller 212 determines that the data is important data.

The controller 212 then determines whether the data is to be written to the turbo area 222 or the normal area 224 of the MLC flash memory 214. When the controller 212 determines that the data is important data, the controller 212 obtains a target block from a plurality of blocks 231˜23M of the turbo area 222 (step 406), and writes the data to a plurality of strong pages of the target block (step 408). In one embodiment, after the target block is obtained, the controller 212 selects a plurality of target pages from pages of the target block, determines whether the target pages are strong pages, and writes the data to the target pages when the target pages are strong pages. When the controller 212 determines that the data is not important data, the controller 212 obtains a target block from a plurality of blocks 251˜25N of the normal area 224 (step 412), and writes the data to a plurality of pages of the target block (step 414) without determining whether the pages are strong pages or weak pages.

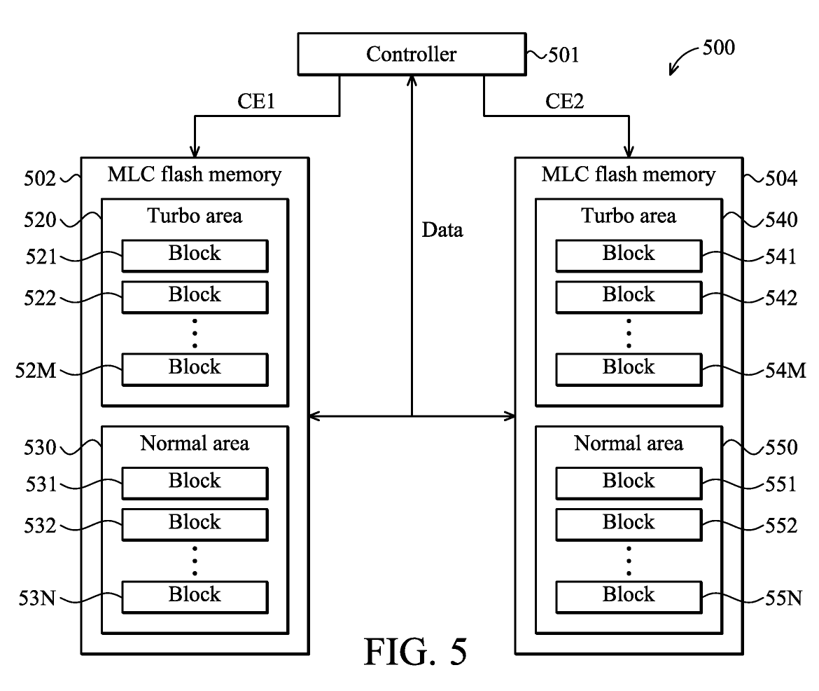

Referring to FIG. 5, a block diagram of an interleaving flash memory device 500 according to the invention is shown. In one embodiment, the interleaving flash memory device 500 comprises a controller 501 and two MLC flash memories 502 and 504. A data bus is coupled between the controller 501 and the two MLC flash memories 502 and 504. The MLC flash memory 502 comprises a turbo area 520 and a normal area 530, and the MLC flash memory 504 comprises a turbo area 540 and a normal area 550. The blocks 521˜52M of the turbo area 520 respectively correspond to the blocks 541˜54M of the turbo area 540, and the blocks 531˜53N of the normal area 530 respectively correspond to the blocks 551˜55N of the normal area 550. The controller 501 writesdata to strong pages of the blocks 521˜52M and 541˜54M of the turbo areas 520 and 540, and writes data to all pages of the blocks 531˜53N and 551˜55N of the normal areas 530 and 550.

The controller 501 respectively enables the MLC flash memories 502 and 504 by respectively enabling chip enable signals CE1 and CE2. When the controller 501 receives data from a host, the controller 501 determines whether the data is important data as described in step 404 of the method 400. When the data is important data, the controller 501 writes data to strong pages of corresponding blocks of the turbo areas 520 and 540 in the MLC flash memories 502 and 504. When the data is not important data, the controller 501 writes data to pages of corresponding blocks of the normal areas 530 and 550 in the MLC flash memories 502 and 504. Because the flash memory device 500 has a single data bus for transmitting data, the controller 501 alternately enables the MLC flash memories 502 and 504, and then alternately writes data to pages of corresponding blocks of the MLC flash memories 502 and 504.

In one embodiment, the controller 501 writes odd sectors of the data to a Y-th strong page of an X-th block of the turbo area 520 of the MLC flash memory 502, and writes even sectors of the data to a Y-th strong page of an X-th block of the turbo area 540 of the MLC flash memory 504. In another embodiment, the controller 501 writes odd bytes of the data to a Y-th strong page of an X-th block of the turbo area 520 of the MLC flash memory 502, and writes even bytes of the data to a Y-th strong page of an X-th block of the turbo area 540 of the MLC flash memory 504. In addition, to prevent the blocks 521˜52M and 541˜54M of the turbo areas 520 and 540 from being exchanged with the blocks 531˜53N and 551˜55N of the normal areas 530 and 550, the controller 501 independently performs wear-leveling on the blocks 521˜52M and 541˜54M of the turbo areas 520 and 540, and independently performs wear-leveling on the blocks 531˜53N and 551˜55N of the normal areas 530 and 550.

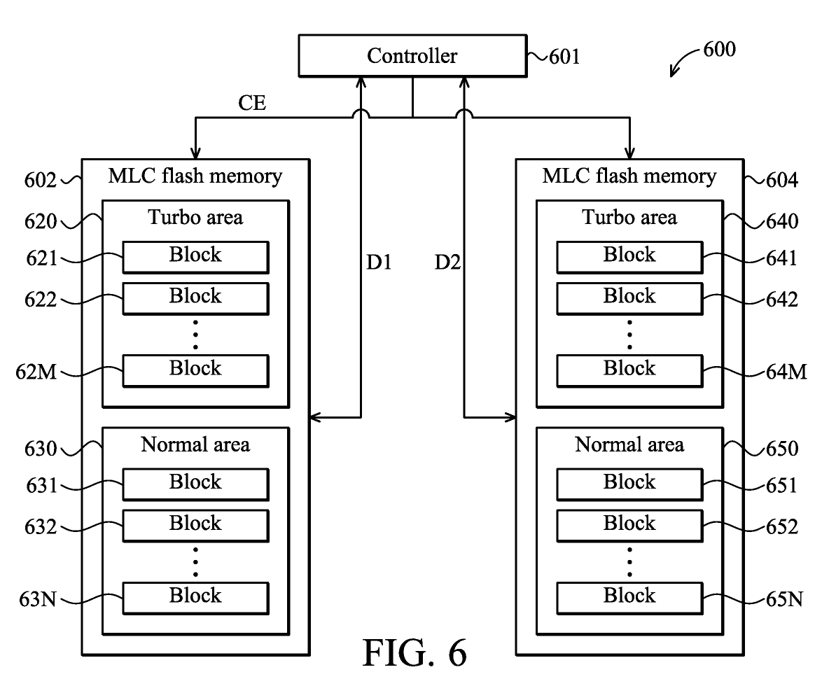

Referring to FIG. 6, a block diagram of a multi-channel flash memory device 600 according to the invention is shown. In one embodiment, the multi-channel flash memory device 600 comprises a controller 601 and two MLC flash memories 602 and 604. A data bus D1 is coupled between the controller 601 and the MLC flash memories 602, and a data bus D2 is coupled between the controller 601 and the MLC flash memories 604. The MLC flash memory 602 comprises a turbo area 620 and a normal area 630, and the MLC flash memory 604 comprises a turbo area 640 and a normal area 650. The blocks 621˜62M of the turbo area 620 respectively correspond to the blocks 641˜64M of the turbo area 640, and the blocks 631˜63N of the normal area 630 respectively correspond to the blocks 651˜65N of the normal area 650. The controller 601 writes data to strong pages of the blocks 621˜62M and 641˜64M of the turbo areas 620 and 640, and writes data to all pages of the blocks 631˜63N and 651˜65N of the normal areas 630 and 650.

The controller 601 writes data to the MLC flash memory 602 via the data bus D1, and writes data to the MLC flash memory 604 via the data bus D2. When the controller 601 receives data from a host, the controller 601 determines whether the data is important data as step 404 of the method 400. When the data is important data, the controller 601 writes data to strong pages of corresponding blocks of the turbo areas 620 and 640 in the MLC flash memories 602 and 604. When the data is not important data, the controller 601 writes data to pages of corresponding blocks of the normal areas 630 and 650 in the MLC flash memories 602 and 604. The controller 601 alternately writes data to pages of corresponding blocks of the MLC flash memories 602 and 604.

In one embodiment, the controller 601 writes odd sectors of the data to a Y-th strong page of an X-th block of the turbo area 620 of the MLC flash memory 602, and writes even sectors of the data to a Y-th strong page of an X-th block of the turbo area 640 of the MLC flash memory 604. In another embodiment, the controller 601 writes odd bytes of the data to a Y-th strong page of an X-th block of the turbo area 620 of the MLC flash memory 602, and writes even bytes of the data to a Y-th strong page of an X-th block of the turbo area 640 of the MLC flash memory 604. In addition, to prevent the blocks 621˜62M and 641˜64M of the turbo areas 620 and 640 from being exchanged with the blocks 631˜63N and 651˜65N of the normal areas 630 and 650, the controller 601 independently performs wear-leveling on the blocks 621˜62M and 641˜64M of the turbo areas 620 and 640, and independently performs wear-leveling on the blocks 631˜63N and 651˜65N of the normal areas 630 and 650.

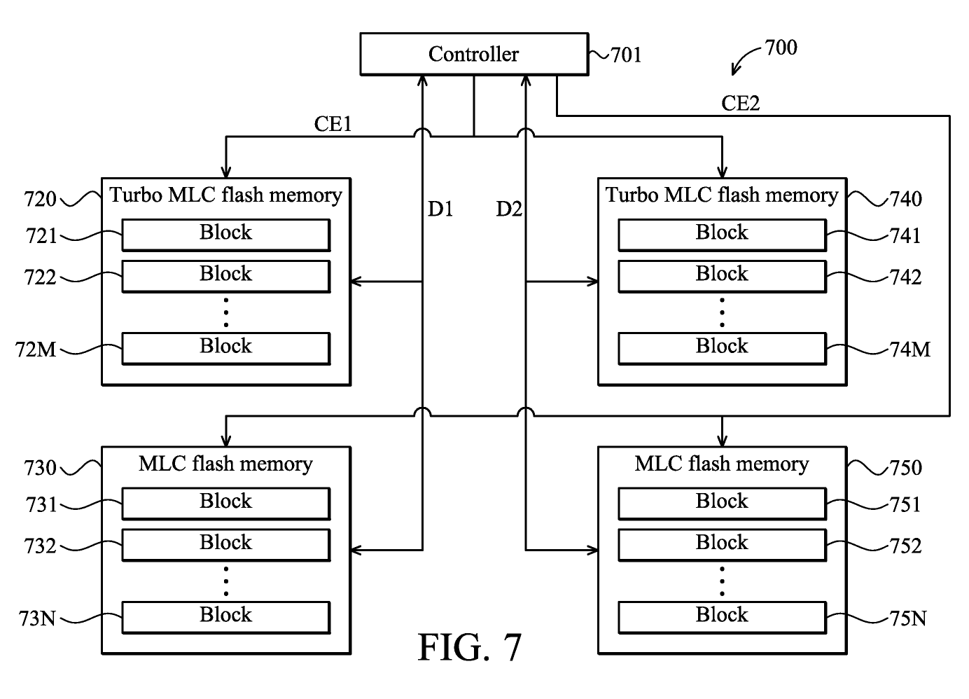

Referring to FIG. 7, a block diagram of a multi-channel interleaving flash memory device 700 according to the invention is shown. In one embodiment, the flash memory device 700 comprises a controller 701, two turbo MLC flash memories 720 and 740, and two MLC flash memories 730 and 750. The controller 701 is coupled to the turbo MLC flash memory 720 and the MLC flash memory 730 via a data bus D1, and is coupled to the turbo MLC flash memory 740 and the MLC flash memory 750 via a data bus D2. Blocks 721˜72M of the turbo MLC flash memory 720 respectively correspond to blocks 741˜74M of the turbo MLC flash memory 740, and blocks 731˜73N of the MLC flash memory 730 respectively correspond to blocks 751˜75M of the MLC flash memory 750. The controller 701 writes data to strong pages of the blocks 721˜72M and 741˜74M of the turbo MLC flash memories 720 and 740, and writes data to all pages of the blocks 731˜73N and 751˜75N of the MLC flash memories 730 and 750.

The controller 701 enables the turbo MLC flash memories 720 and 740 via a chip enable signal CE1, and enables the MLC flash memories 730 and 750 via a chip enable signal CE2. When the chip enable signal CE1 is enabled, the controller 701 sends data to the turbo MLC flash memory 720 via the data bus D1, and sends data to the turbo MLC flash memory 740 via the data bus D2. When the chip enable signal CE2 is enabled, the controller 701 sends data to the MLC flash memory 730 via the data bus D1, and sends data to the MLC flash memory 750 via the data bus D2. When the controller 701 receives data from a host, the controller 701 determines whether the data is important data as step 404 of the method 400. When the data is important data, the controller 701 writes the data to strong pages of corresponding blocks of the turbo MLC flash memories 720 and 740. When the data is not important data, the controller 701 writes the data to pages of corresponding blocks of the MLC flash memories 730 and 750.

In one embodiment, the controller 701 writes odd sectors of the data to a Y-th strong page of an X-th block of the turbo MLC flash memory 720, and writes even sectors of the data to a Y-th strong page of an X-th block of the turbo MLC flash memory 740. In another embodiment, the controller 601 writes odd bytes of the data to a Y-th strong page of an X-th block of the turbo MLC flash memory 720, and writes even bytes of the data to a Y-th strong page of an X-th block of the turbo MLC flash memory 740. In addition, to prevent the blocks 721˜72M and 741˜74M of the turbo MLC flash memories 720 and 740 from being exchanged with the blocks 731˜73N and 751˜75N of the MLC flash memories 730 and 750, the controller 701 independently performs wear-leveling on the blocks 721˜72M and 741˜74M of the turbo MLC flash memories 720 and 740, and independently performs wear-leveling on the blocks 731˜73N and 751˜75N of the MLC flash memories 730 and 750.

A controller 212 divides a plurality of blocks of an MLC flash memory 214 shown in FIG. 2 into two groups of blocks 231˜23M and 251˜25N respectively storing data in the turbo area 222 and the normal area 224. The controller 212 only uses strong pages of the blocks 231˜23M of the turbo area 222 to store data, thereby increasing data access speed of the turbo area 222 and improving performance of the turbo area 222. When a flash memory device comprises a plurality of MLC flash memories, a controller of the flash memory device can also use strong pages of the MLC flash memories for data storage.

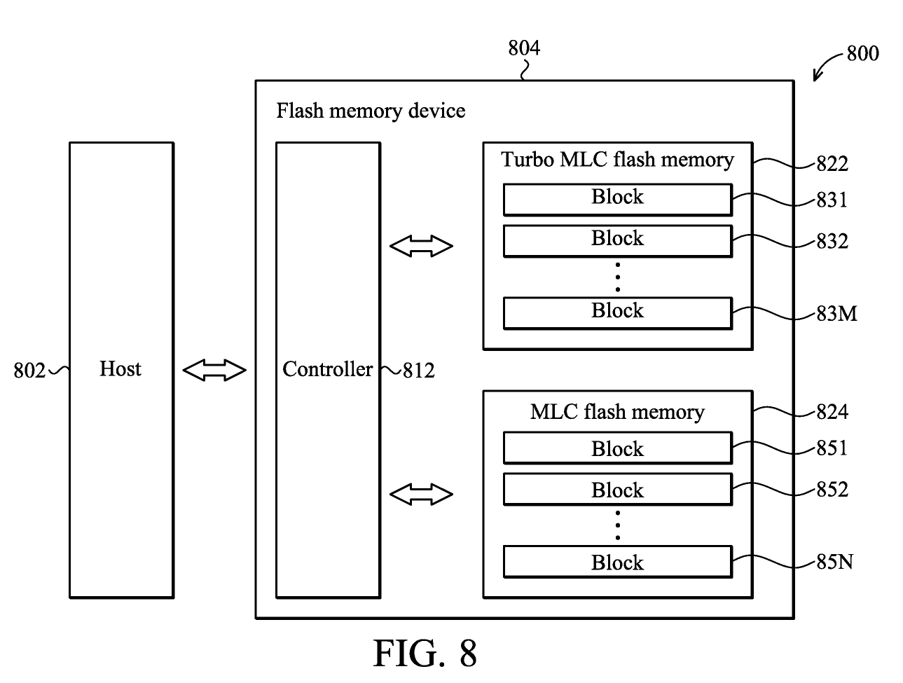

Referring to FIG. 8, a block diagram of a flash memory device 804 according to the invention is shown. In one embodiment, the flash memory device 804 comprises a controller 812, a turbo MLC flash memory 822, and an MLC flash memory 824. The controller 812 writes data to strong pages of blocks 831˜83M of the turbo MLC flash memory 822, thus increasing data access speed for accessing data stored in the turbo MLC flash memory 822, and increasing data endurance and data retention of blocks 831˜83M of the turbo MLC flash memory 822. Meanwhile, the controller 812 uses all pages of the blocks 851˜85N of the MLC flash memory 824 to store data, thus maximizing data storage capacity of the MLC flash memory 824. The flash memory device 804 shown in FIG. 8 therefore comprises two kinds of flash memories 822 and 824 with different properties as the flash memory device 204 shown in FIG. 2.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A flash memory device, coupled to a host, comprising:
a multiple-level-cell (MLC) flash memory, comprising a turbo area and a normal area, wherein the turbo area comprises a plurality of first blocks, the normal area comprises a plurality of second blocks, and each of the first blocks and the second blocks comprises a plurality of pages, wherein the pages of the first blocks and the second blocks are divided into strong pages with high data endurance and weak pages with low data endurance; and
a controller, receiving data to be written to the MLC flash memory from the host, determining whether the data is important data, writing the data to the strong pages of the first blocks of the turbo area when the data is important data, and writing the data to the pages of the second blocks of the normal area when the data is not important data.

2. The flash memory device as claimed in claim 1, wherein a logical address range used by the host is divided into a first logical address range and a second logical address range according to a boundary value, and the controller receives a logical address of the data from the host and compares the logical address with the boundary value to determine whether the data is important data.

3. The flash memory device as claimed in claim 2, wherein when the logical address is less than the boundary value, the controller determines that the data is important data.

4. The flash memory device as claimed in claim 1, wherein the controller maintains a first address link table which stores a mapping relationship between physical addresses of the first blocks of the turbo area and logical addresses of the first logical address range, and maintains a second address link table which stores a mapping relationship between physical addresses of the second blocks of the normal area and logical addresses of the second logical address range.

5. The flash memory device as claimed in claim 1, wherein the controller performs wear-leveling on the first blocks of the turbo area, and performs wear-leveling on the second blocks of the normal area, and does not perform wear-leveling between the first blocks of the turbo area and the second blocks of the normal area.

6. The flash memory device as claimed in claim 1, wherein when the data is determined to be important data, the controller selects a target block from the first blocks of the turbo area, selects a plurality of target pages from the pages of the target block, determines whether the target pages are strong pages, and writes the data into the target page when the target pages are strong pages.

7. The flash memory device as claimed in claim 1, wherein the controller determines the data to be important data when the data is system data of the host, and determines the data to not be important data when the data is user data.

8. A method for writing data to a flash memory device, wherein the flash memory device is coupled to a host, the method comprising:
dividing a plurality of blocks of a multiple-level-cell (MLC) flash memory into a plurality of first blocks of a turbo area and a plurality of second blocks of a normal area, wherein each of the first blocks and the second blocks comprises a plurality of pages, and the pages of the first blocks and the second blocks are classified into strong pages with high data endurance and weak pages with low data endurance; and
receiving data to be written to the MLC flash memory from the host;
determining whether the data is important data;
writing the data to the strong pages of the first blocks of the turbo area when the data is important data; and
writing the data to the pages of the second blocks of the normal area when the data is not important data.

9. The method as claimed in claim 8, wherein the method further comprises dividing a logical address range used by the host into a first logical address range and a second logical address range according to a boundary value, and determination of whether the data is important data comprises:
receiving a logical address of the data from the host; and
comparing the logical address with the boundary value to determine whether the data is important data.

10. The method as claimed in claim 9, wherein when the logical address is less than the boundary value, the data is determined to be important data.

11. The method as claimed in claim 9, wherein the method further comprises:
maintaining a first address link table which stores a mapping relationship between physical addresses of the first blocks of the turbo area and logical addresses of the first logical address range; and
maintaining a second address link table which stores a mapping relationship between physical addresses of the second blocks of the normal area and logical addresses of the second logical address range.

12. The method as claimed in claim 8, wherein the method further comprises:
performing wear-leveling between the first blocks of the turbo area; and
performing wear-leveling between the second blocks of the normal area,
wherein wear-leveling is not performed between the first blocks of the turbo area and the second blocks of the normal area.

13. The method as claimed in claim 8, wherein when the data is determined to be important data, writing of the data to the strong pages of the first blocks comprises:
selecting a target block from the first blocks of the turbo area;
selecting a plurality of target pages from the pages of the target block;
determining whether the target pages are strong pages; and
writing the data into the target pages when the target pages are strong pages.

14. The method as claimed in claim 8, wherein the data is determined to be important data when the data is system data of the host, and the data is determined to not be important data when the data is user data.

15. A flash memory device, coupled to a host, comprising:
a plurality of multiple-level-cell (MLC) flash memory, each comprising a turbo area and a normal area, wherein the turbo area and the normal area comprises a plurality of blocks, each of the blocks comprises a plurality of pages, and the pages are divided into strong pages with high data endurance and weak pages with low data endurance; and
a controller, receiving data to be written to the flash memory device from the host, determining whether the data is important data, writing the data to the strong pages of a plurality of first blocks of the turbo areas of the MLC flash memories when the data is important data, and writing the data to the pages of a plurality of second blocks of the normal areas of the MLC flash memories when the data is not important data, wherein the first blocks have the same indexes in the MLC flash memories, and the second blocks have the same indexes in the MLC flash memories.

16. The flash memory device as claimed in claim 15, wherein the MLC flash memories comprise a first MLC flash memory and a second MLC flash memory, and when the data is determined to be important data, the controller writes old sectors of the data into a first strong page in the turbo area of the first MLC flash memory, and writes even sectors of the data into a second strong page in the turbo area of the second MLC flash memory, wherein the first strong page has the same index in the first MLC flash memory as that of the second strong page in the second MLC flash memory.

17. The flash memory device as claimed in claim 15, wherein the MLC flash memories comprise a first MLC flash memory and a second MLC flash memory, and when the data is determined to be important data, the controller writes old bytes of the data into a first strong page in the turbo area of the first MLC flash memory, and writes even bytes of the data into a second strong page in the turbo area of the second MLC flash memory, wherein the first strong page has the same index in the first MLC flash memory as that of the second strong page in the second MLC flash memory.

18. The flash memory device as claimed in claim 15, wherein a logical address range used by the host is divided into a first logical address range and a second logical address range according to a boundary value, and the controller receives a logical address of the data from the host and compares the logical address with the boundary value to determine whether the data is important data.

19. The flash memory device as claimed in claim 15, wherein the controller performs wear-leveling on the blocks of the turbo areas of the MLC flash memories, and performs wear-leveling on the blocks of the normal areas of the MLC flash memories, and does not perform wear-leveling between the blocks of the turbo areas and the blocks of the normal areas.

20. The flash memory device as claimed in claim 15, wherein the controller is coupled to the MLC flash memories via a plurality of data buses, and the controller writes portions of the data to the MLC flash memories via the data buses.

21. The flash memory device as claimed in claim 15, wherein the controller enables the MLC flash memories via a plurality of chip enable signals, and the controller alternately enables the MLC flash memories to write portions of the data to the MLC flash memories.

22. A flash memory device, coupled to a host, comprising:
a turbo multiple-level-cell (MLC) flash memory, comprising a plurality of first blocks, wherein each of the first blocks comprises a plurality of pages, and the pages of the first blocks are divided into strong pages with high data endurance and weak pages with low data endurance;
an MLC flash memory, comprising a plurality of second blocks, wherein each of the second blocks comprises a plurality of pages;
a controller, receiving data to be stored into the flash memory device from the host, determining whether the data is important data, writing the data to the strong pages of the first blocks of the turbo MLC flash memory when the data is important data, and writing the data to the pages of the second blocks of the MLC flash memory when the data is not important data.

23. The flash memory device as claimed in claim 22, wherein a logical address range used by the host is divided into a first logical address range and a second logical address range according to a boundary value, and the controller receives a logical address of the data from the host and compares the logical address with the boundary value to determine whether the data is important data.

24. The flash memory device as claimed in claim 23, wherein when the logical address is less than the boundary value, the controller determines that the data is important data.

25. The flash memory device as claimed in claim 23, wherein the controller maintains a first address link table which stores a mapping relationship between physical addresses of the first blocks of the turbo MLC flash memory and logical addresses of the first logical address range, and maintains a second address link table which stores a mapping relationship between physical addresses of the second blocks of the MLC flash memory and logical addresses of the second logical address range.

26. The flash memory device as claimed in claim 22, wherein the controller performs wear-leveling on the first blocks of the turbo MLC flash memory, and performs wear-leveling on the second blocks of the MLC flash memory, and does not perform wear-leveling between the first blocks of the turbo MLC flash memory and the second blocks of the MLC flash memory.

27. The flash memory device as claimed in claim 22, wherein when the data is determined to be important data, the controller selects a target block from the first blocks of the turbo MLC flash memory, selects a plurality of target pages from the pages of the target block, determines whether the target pages are strong pages, and writes the data into the target page when the target pages are strong pages.

28. The flash memory device as claimed in claim 22, wherein the controller determines the data to be important data when the data is system data of the host, and determines the data to not be important data when the data is user data.
